(19) United States
(12) Patent Application Publication
(10) Pub. No.: US 2017/0177175 A1
(43) Pub. Date: Jun. 22, 2017

(54) SYSTEM AND METHOD FOR EDITING AND GENERATING MULTIMEDIA CONTENTS ACCORDING TO DIGITAL PLAYBOOKS

(71) Applicant: MING-CHANG LAI, Taipei (TW)

(72) Inventor: MING-CHANG LAI, New Taipei (TW)

(21) Appl. No.: 15/385,869

(22) Filed: Dec. 21, 2016

Related U.S. Application Data
(60) Provisional application No. 62/270,527, filed on Dec. 21, 2015.

(51) Int. Cl. G06F 3/0482; G06F 17/24

(52) U.S. Cl. CPC G06F 3/0482; G06F 17/24

(57) ABSTRACT

A machine-implemented method for producing multimedia is executed by a server. The server receives a selection of digital playbook defining a time schedule and a plurality of material requirements from a computing device, and retrieves the selected digital playbook from a digital playbook database. Then, the server generates at least one query of material content for each of the content requirements, and identifies a set of material candidates for producing multimedia from at least one material database. The server generates a multimedia file based on the material candidates and the time schedule.

### CROSS-REFERENCE TO RELATED APPLICATIONS

This application claims priority to Provisional Patent Application No. 62/270,527 filed on Dec. 21, 2015, the contents of which are incorporated by reference herein.

### FIELD

The subject matter herein generally relates to multimedia editing, especially online multimedia editing service. The subject matter may further be implemented as application software in electronic computing devices or multimedia recording devices.

### BACKGROUND

Multimedia (especially video) editing and generating software are widely commercialized in the market. Generally, multimedia editing and generating software provide users with the option to integrate images (videos, photos), sounds (vocal, tunes, music), and texts (art, subtitles) into a multimedia file. The software may also enable users to manually configure and edit the multimedia file by adjusting the multimedia duration, sound volume, image brightness, special effects like fade in/out, and subtitle configuration (e.g. fonts, color, position, timing, duration). To complete post-production work, such as manually editing the multimedia file(s) to arrive at a work product through conventional multimedia editing and generating software, users usually need sufficient skills and experience to operate the software and to combine stories, scenario, music, and subtitles to create works of art. Even for a skillful user, using multimedia editing and generating software to edit their work can be a very costly and time consuming process. Therefore, the multimedia editing and generating software are widely used by professional users having significant experience in the multimedia editing and creation process, and rarely by general users with little to no experience.

Within the present disclosure, solutions are provided to set forth some example situations, the exemplary solutions should not in any way be construed as limiting the scope of the present disclosure. Similarly, extensive applications may not be exhaustively described within the scope of the present disclosure.

### BRIEF DESCRIPTION OF THE DRAWINGS

Implementations of the present technology will now be described, by way of example only, with reference to the attached figures.

FIG. 1 is a functional block diagram of one exemplary embodiment of a multimedia editing and generating system.

FIGS. 2A and 2B are schematic illustrations of one exemplary embodiment of a digital playbook.

FIGS. 2C and 2D are schematic illustrations of one exemplary embodiment of digital scripts defined in the digital playbook of FIGS. 2A and 2B.

FIG. 3A is a flowchart of one exemplary embodiment of a multimedia editing process.

FIG. 3B is a flowchart of one exemplary embodiment of a multimedia generating process.

FIG. 3C is a flowchart of one exemplary embodiment of a multimedia generating process,

FIG. 4A is a schematic illustration of one exemplary embodiment of an online multimedia editing and generating platform.

FIG. 4B is a schematic illustration of one exemplary embodiment of an online multimedia editing and generating platform accepting material content order.

FIG. 4C is a schematic illustration of one exemplary embodiment of an online multimedia editing and generating platform providing advertisement reservation.

FIG. 4D is a schematic illustration of one exemplary embodiment of an online multimedia editing and generating platform creating a digital playbook.

FIG. 5A is a flowchart of one exemplary embodiment of an online multimedia editing and generating process.

FIG. 5B is a flowchart of one exemplary embodiment of an online material content ordering and multimedia generating process.

FIG. 5C is a flowchart of one exemplary embodiment of an online advertisement production and reservation process.

FIG. 5D is a flowchart of one exemplary embodiment of an online playbook creation process.

FIG. 6 is a block diagram of one exemplary embodiment of a client side configuration corresponding to the application server 109 of the multimedia editing and generating system 100 of the present disclosure.

FIG. 7 is a flowchart of one exemplary embodiment of a client-side multimedia editing and generating process.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

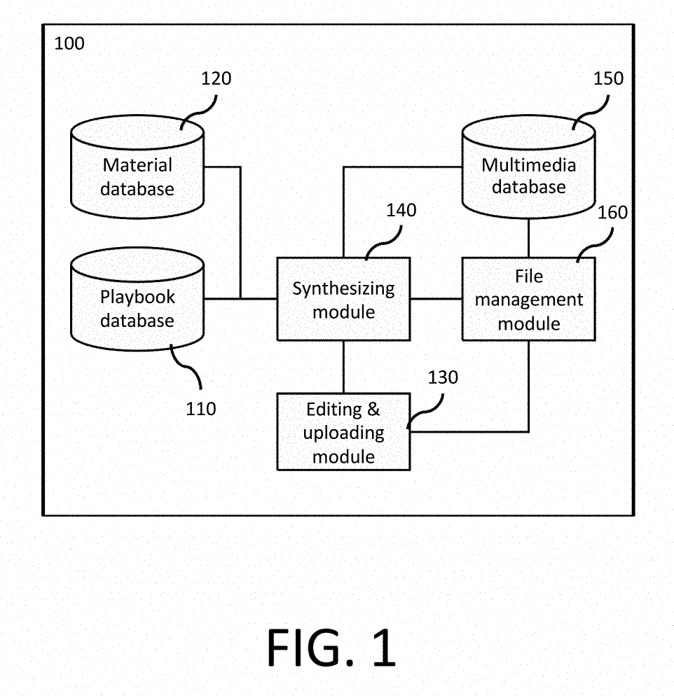

Referring to FIG. 1, a multimedia editing and generating system 100 of the present disclosure may receive contents from a user (denoted as “user contents” in the following paragraphs) and create a multimedia file containing at least part of the user contents. The created multimedia will be denoted as “work product” of the multimedia editing and generating system 100 in the following paragraphs. The multimedia editing and generating system 100 of the present disclosure may further provide contents as material (denoted as “material contents” in the following paragraphs) for user selection to be included in the work product. The aforementioned user contents, material contents, and work product may be any type of multimedia including, but not limited to, images (e.g. photos, hand-painted pictures, and digitally synthesized images), sounds (e.g. speeches, music, and MIDI defining electronically synthesized music), videos (may also include audio), 2D/3D animations, texts (e.g. articles or subtitles in multimedia).

The multimedia editing and generating system 100 of the present disclosure may comprise a playbook database 110 storing digital playbooks, each of which may correspond to a type of a work product. Each of the digital playbooks may be a pre-edited template for work products for conveying specific ideas, characters, emotions, and feelings or meanings for specific occasions. For example, a digital playbook of the present disclosure may be for a fun or celebratory occasions such as celebrating a friend's birthday, while another digital playbook may convey yearning sympathy or condolences for the passing of an old friend. Each of the digital playbooks may define material contents and user contents included in the corresponding work product. The digital playbook may also define the schedule (e.g. timing or ordering) and configuration of contents included in the work product.

The multimedia editing and generating system 100 may also comprise a material database 120 that stores material contents defined in the digital playbooks. In at least one exemplary embodiment, the material database 120 may be maintained by the administrator of the multimedia editing and generating system 100 since the material contents in the material database 120 can be used by the client devices for producing the work product. In at least one exemplary embodiment, for acquiring the material content candidates based on requirements defined in the digital playbooks, the material database 120 may further store and maintain metadata of the material contents. The metadata of the material contents maintained in the material database 120 may include file metadata. For example, when the material content is a photo, the metadata may comprise file format, file size, recording time, recording place, brightness, color settings, aperture settings, focus settings and shutter settings. When the material contents is an audio file containing sounds or music, the metadata may comprise tempo, volume, sound track, genre of music, music instrument, performer, composer, lyric and voice part of the music. When the material contents contains text, the metadata may comprise font, color, size, style and file format. In at least one exemplary embodiment, the metadata may further contain digital right management (DRM) information of the file such as scope, starting date, ending date, price or other commercial terms of the right.

The metadata of the material contents may further include the type, nature, or style of the material content such as sport content, action scenes, family content, a serious or somber occasion. The metadata of the material contents may further include scene or scenery information such as mountains, kids, sun, sunrise, sunset, ocean, bicycle and swimming. Therefore, the material contents in the material database 120 may provide users with the material content candidates based on the desired style, type, or nature of the material contents. In at least one exemplary embodiment, the digital playbooks may only query the metadata of the material contents to suggest possible material contents candidates from the material database 120. The material contents candidates returned from the query may be selected from metadata defined for the material content in the digital playbooks. Thus, candidates for the query may include only a portion of all possible material content candidates that the user may select from within the material database 120. Moreover, the number of material content candidates suggested by the digital playbook may increase and/or improve as new material contents are entered and stored in the material database 120. The new material contents may be imported by a system administrator of the multimedia editing and generating system 100. In at least one exemplary embodiment, the material contents may be uploaded by users of the multimedia editing and generating system 100 for repeated uses. In at least one exemplary embodiment, a machine learning mechanism may also be implemented for extracting metadata of the material contents in the material database 120. As a result, the material content candidates suggested by the digital playbook may be more precise or specific as new metadata is extracted from the material contents in the material database 120.

The multimedia editing and generating system 100 may further comprise an editing and uploading module 130. The editing and uploading module 130 may provide one or more user interfaces for selecting digital playbooks, receiving user contents according to the selected digital playbook, and selecting material contents according to the selected digital playbook. The editing and uploading module 130 may provide a user querying for digital playbooks with a list of digital playbooks for user selection based on the query (e.g. specific ideas, characters, emotions, feelings, or specific occasions). The editing and uploading module 130 may further analyze the selected digital playbook to obtain information about material contents candidates and user contents requirements defined in the selected digital playbook. Therefore, the editing and uploading module 130 may provide a list of material contents for user selection as well as receive user contents from a user. The editing and uploading module 130 may obtain a schedule and configuration of the contents including the material contents and the user contents defined in the selected digital playbook. The configuration may include properties of multimedia which may be adjustable (e.g. image brightness, sound volume, fonts of subtitles and/or shape of 3D graphic models). Therefore, the editing and uploading module 130 may further provide one or more user interfaces for the user to manually adjust the aforementioned schedule or configuration. However, the editing and uploading module 130 may not be limited to only providing users with manual adjustment. The editing and uploading module 130 may also match the material contents to the requirements defined by the digital playbook without manual confirmation from the users. Some of the mechanisms for matching material contents may be through sorting heuristics/algorithms defined in the digital playbook for the editing and uploading module 130, allowing for direct retrieval of the best matched material contents from the material database 120. Similarly, in at least one exemplary embodiment, a user database for storing user data and configuration may be implemented; so that the editing and uploading module 130 may retrieve the best matched user contents from the user database according to the heuristics/algorithms defined in the digital playbook.

The multimedia editing and generating system 100 may comprise a synthesizing module 140 for synthesizing the received user contents and the selected material contents according to the selected digital playbooks. The synthesizing module 140 may retrieve the schedule in the selected digital playbook and arrange the selected material contents and received user contents accordingly. The synthesizing module 140 may further retrieve the schedule and configuration of the contents including the material contents and the user contents and process the selected material contents and received user contents for synthesizing material contents and user contents into a work product.

The multimedia editing and generating system 100 may further comprise a multimedia database 150 for storing work products synthesized by the synthesizing module 140, and a file management module 160 to provide a user interface for downloading and/or sharing the work product with another user or computer. In at least one exemplary embodiment, the file management module 160 may further determine a period for storing the work products in the multimedia database 150. If the storing duration of the work products stored in the multimedia database 150 exceeds a predetermined period (e.g. a week, two weeks, a month, and a quarter), the file management module 160 may not reserve the work products. Instead, the file management module 160 may reserve the digital playbooks, the corresponding user contents, and corresponding configurations of the material contents. The synthesizing module 140 may reproduce the work product by the aforementioned digital playbooks, the corresponding user contents, and corresponding configurations of the material contents. Additionally, the editing and uploading module 130 may provide user interfaces for adjusting a schedule and configuration of contents defined in the digital playbook.

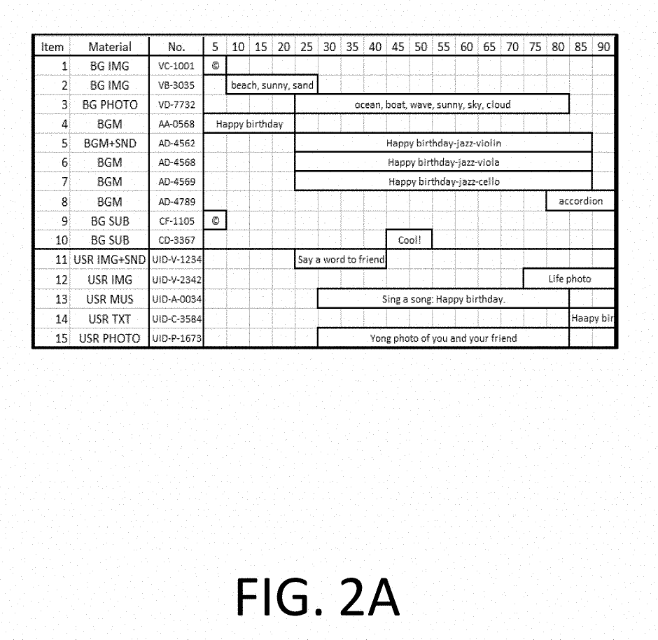

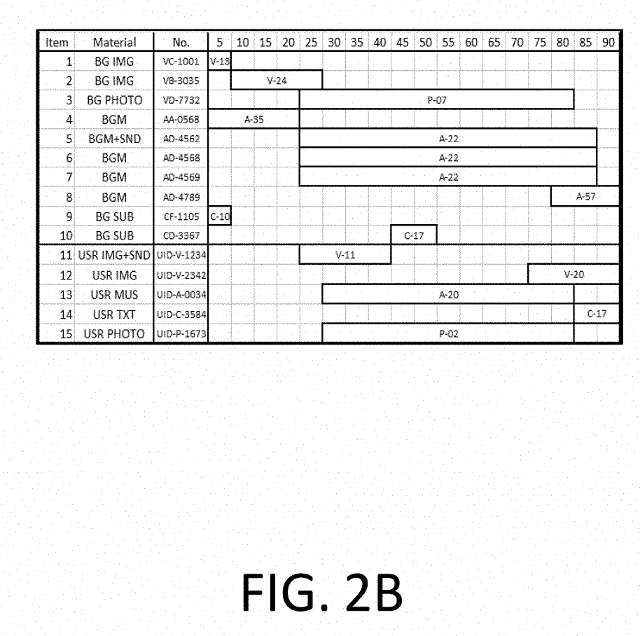

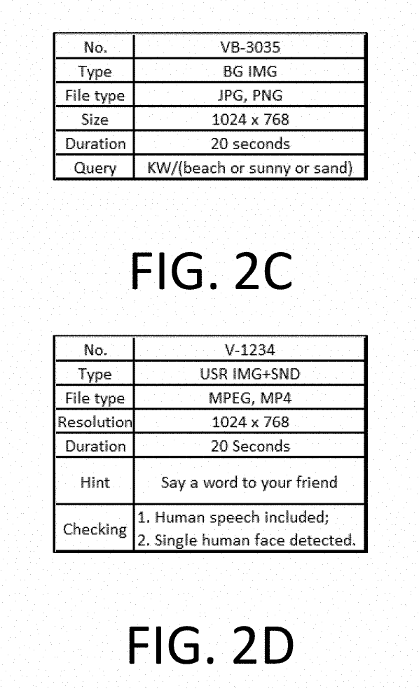

Referring to FIG. 2A, an exemplary embodiment of a data structure of a digital playbook is illustrated in FIG. 2A. The data structure of the digital playbook is presented as a table having file type, file number, and time schedule as its x-axis. The y-axis of the table corresponds to records of each content requirement contained in the table. FIG. 2A is an exemplary illustration of the data structure of the digital playbook, and the data structure of the digital playbooks may be presentations other than that shown in FIG. 2A.

Referring again to FIG. 2A, the digital playbook may define material contents, user contents requirements, and a scheduling of the required material and user contents. For example, as shown in FIG. 2A, the digital playbook contains 10 material contents (item 1˜10) and 5 user contents (item 11˜15) each scheduled in a total of 90 seconds. Additionally, the digital playbook may define file type, duration, and name of each file as material content and/or user content. For example, the file type “BG IMG” of item 1 listed in the table may correspond to “back ground image” scheduled in first 5 unit of time (for example, 5 seconds). The requirement of item 1 presented as “©” in the table may correspond to “copyright designation”. Therefore, the digital playbook may define item 1 as a background image related to “copyright designation” as material content scheduled from 0 second to 5 second. In at least one exemplary embodiment, the requirement of item 1 can be substituted by “trademark designation” presented as “™” or “®”. In at least one exemplary embodiment, the digital playbook having the trademark designation can be created by a product company for advertising their products. For example, a baby product company can have a digital playbook including their trademark or their product information for the users to produce a baby birth video. In at least one exemplary embodiment, the requirements of material contents defined within the digital playbook may correspond to one or more queries to the material database 120. The editing and uploading module 130 may retrieve material content candidates from the material database 120 for user selection according to the queries. For example, illustrated in FIG. 2A, item 2 may correspond to a background image related to “beach, sunny, sand” as material content scheduled from 5 second to 25 second. The term “beach, sunny, sand” may correspond to a query for material contents in the material database 120 as material content candidates for user selection through the editing and uploading module 130. In at least one exemplary embodiment, the requirements of user contents defined within the digital playbook may correspond to one or more hints to users through the editing and uploading module 130. For example, illustrated in FIG. 2A, item 12 with file type “USR IMG” may correspond to a user image related to “life photos” as user content scheduled from 70 second to 90 second. The term “life photos” may provide descriptive information of the user contents that is presented to users through the editing and uploading module 130. Moreover, the editing and uploading module 130 may provide images and/or texts as suggestive information for users to provide, for example, life photos about their friends. The editing and uploading module 130 may further provide heuristics/algorithms for checking whether an uploaded file for user content meets the requirements defined in the digital playbook.

In at least one exemplary embodiment, for synthesizing material contents and user contents into a work product, the digital playbook may further define a blank or temporary place holder for each material content and user content requirement. Therefore, digital playbooks stored in the playbook database 110 do not need to define a specific file to be scheduled. The editing and uploading module 130 may also provide user interfaces for requesting selection and/or upload of specific files to be added as material contents and user contents for synthesizing into a work product. For example, illustrated in FIG. 2A, the “No.” column in the table may be blank while the digital playbook storing in the playbook database 110. After editing and uploading module 130 searching the material database for material content candidates and selecting specific files as material contents, the “No.” column in the table, as shown in FIG. 2A, may be filled with a specific file number such as “VC-1001” for item 1. Similarly, after editing and uploading module 130 providing hints and receiving specific files as user contents, the “No.” column in the table, as shown in FIG. 2A, may be filled with a specific file number such as “UID-V-1234” for item 11.

Referring to FIG. 2B, an exemplary embodiment of schedule in a digital playbook is illustrated, which is also presented as a table having file type, file number and time schedule as its x-axis. The y-axis of the table corresponds to records of each content schedule contained in the table. FIG. 2B is also an experimental illustration of the data structure of the schedule of the digital playbook. The data structure of the schedule of the digital playbooks may also correspond to presentations other than which of FIG. 2B as well.

Referring again to FIG. 2B, the schedule of the digital playbook may define relationship between the contents and time as also illustrated in FIG. 2A. For example, item 1 listed in the table may correspond to a file “VC-1001” as material content scheduled in first 5 unit of time (for example, 5 seconds). The code “V-13” corresponding to item 1, presented in the table, may correspond to configurations of the file “VC-1001”. The configurations may include adjustable parameters of files to be defined as material contents or user contents. For example, configurations for an image file may correspond to fade in/out effect, color setting, brightness, deformation and/or background removal of the image; configurations for an audio file may correspond to sound volume, equalizer settings and/or echo settings of the sound; and configurations for text as subtitles may correspond to starting time, position, animating effect, color settings and/or font settings of the text. In at least one exemplary embodiment, the configurations of the schedule stored along with the digital playbooks in the playbook database 110 may have default values optimized for the conveying or emphasizing specific ideas, characters, emotions, feelings or meanings defined in the digital playbooks. The editing and uploading module 130 may read the default values and provide user interfaces for user adjusting. The code defined in the table may correspond to a combination of the default values of the parameters included in the configurations. Moreover, the schedule may be, as shown in FIG. 2B, separate data from the digital playbook. However, the schedule may also be integrated into the digital playbook shown in FIG. 2A by amending configuration to each content requirement. In at least one exemplary embodiment, if a user needs to pay and/or meet other commercial terms for obtaining material contents, information related with the payment and/or the commercial term may also be included in the digital script for data exchange to accomplish the payment or necessary procedures to meet the commercial terms. For example, the editing and uploading module 130 may extract and provide the aforementioned information in the digital script to a user. While a user confirming the order for the material content, the editing and uploading module 130 may provide the information and the order confirmation to a transaction server (such as servers providing credit card payment services or a 3rd party payment services) and receive a confirmation for payment before providing the material content selected by the user.

Referring to FIG. 2C, once a digital playbook is selected, for each material content requirement in the digital playbook, the editing and uploading module 130 may generate a corresponding digital script for querying material content candidates from the material database 120. For example, as shown in FIG. 2C, for item 2 in FIGS. 2A and 2B, the editing and uploading module 130 may generate a digital script containing file number (which may be blank before user selection), content type (such as “BG IMG” representing background image), file type (“JPG, PNG” in FIG. 2C), duration of the material content scheduled (20 seconds in FIG. 2C) and a query corresponding to the requirement (such as “KW/(beach or sunny or sand)” representing union of material contents including keywords “beach”, “sunny” or “sand”.). The digital script may have benefits for data exchange between different devices implemented with the material database 120 and the editing and uploading module 130.

Referring to FIG. 2D, for each user content requirement in selected the digital playbook, the editing and uploading module 130 may also generate a corresponding digital script for acknowledging users to upload a file as the required user content accordingly. For example, as shown in FIG. 2D, for item 11 in FIGS. 2A and 2B, the editing and uploading module 130 may generate a digital script containing file number (which may be blank before receiving a file uploaded by a user), content type (such as “USR IMG+SND” representing images and sounds provided by users), file type (“MPEG, MP4” in FIG. 2D), duration of the user content scheduled (20 seconds in FIG. 2D) and a hint corresponding to the requirement (such as “Say a word to your friend” to be presented by the editing and uploading module 130 in FIG. 2D). In at least one exemplary embodiment, if there is a digital playbook for combining a music video (MV) with a user audio or a user video, the hint of the digital playbook can be a song lyric or other information. Thus, the user can sing the song in MV based on the hint to make the user's voice match the song. In at least one exemplary embodiment, a checking mechanism corresponding to the requirement may also be included. For example, as illustrated in FIG. 2D, the checking mechanism corresponding to hint of the requirement “Say a word to your friend” may include detecting whether human speech is included in the uploaded video and whether a single human face is included in the uploaded video.

In at least one exemplary embodiment, if a digital playbook involves participation of one or more users for uploading files as user contents, the editing and uploading module 130 may provide digital scripts involved with each user for acknowledging requirements and receiving files as user contents. For example, if the digital playbook involves two users each responsible for providing three files as user contents, the editing and uploading module 130 may generate the corresponding six digital scripts and providing each three corresponding digital scripts to each of the two users. Therefore, cooperation for producing a work product by the system 100 may be enabled by the generating and providing of digital scripts. In at least one exemplary embodiment, if a user content requirement involves real-time recording of images, sounds or videos, settings of the recording may also be included in the corresponding digital script for providing a recording device to record accordingly. Moreover, if the recording involves more than one apparatus, the editing and uploading module 130 may generate digital scripts including corresponding settings for each apparatus to perform accordingly. For example, if the real time recording involves a video camcorder, the editing and uploading module 130 may set a lighting equipment for generating light effects and a music player for playing background music. The editing and uploading module 130 may generate digital scripts including settings for the video camcorder, the lighting equipment and the music player and providing each of the digital scripts to each apparatus. In at least one exemplary embodiment, the digital playbook can involve the users retrieving message, image, photo or video from an external online system, such as instant messaging system. Thus, the users can select the message, image, photo or video on the external online system as the user contents if the multimedia editing and generating system 100 is communicably coupled to the external online system. In at least one embodiment, the digital playbook involves the user retrieving the user information including movement, sigh, or touch and combining the user information with the viral environment. For example, the editing and uploading module 130 may generate digital scripts including settings for the virtual reality device. In at least one embodiment, the digital playbook involves the user retrieving the real-world image and combining the real-world image with the virtual image. For example, the editing and uploading module 130 may generate digital script for providing a recording device to record and for providing a computing device to combine the real-world image with the virtual information.

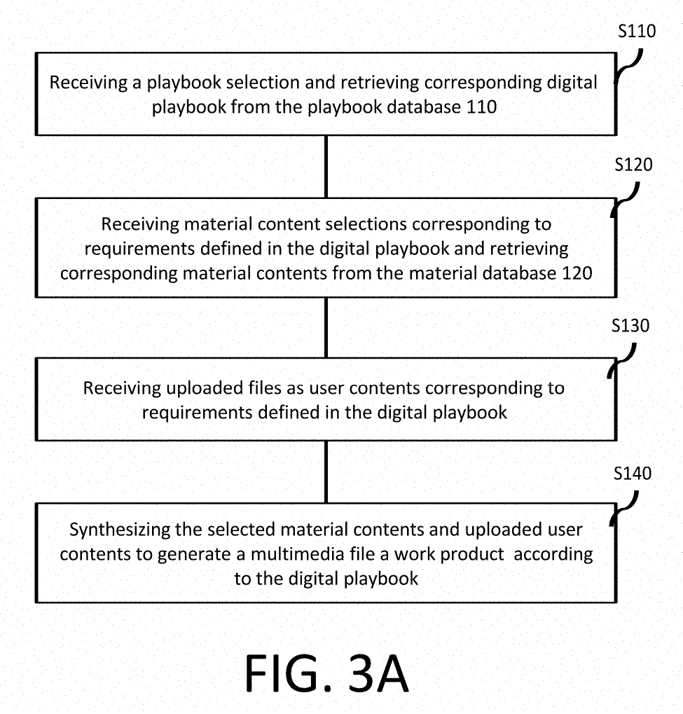

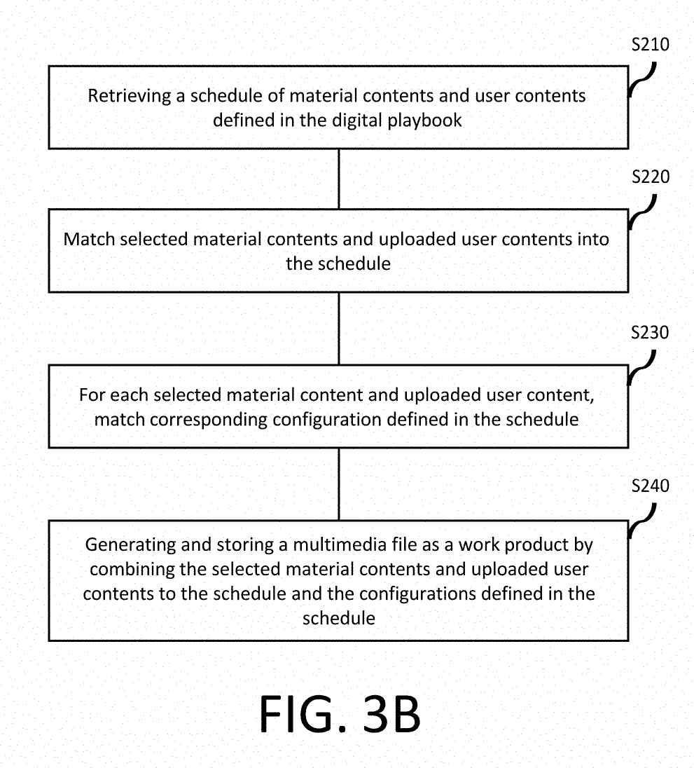

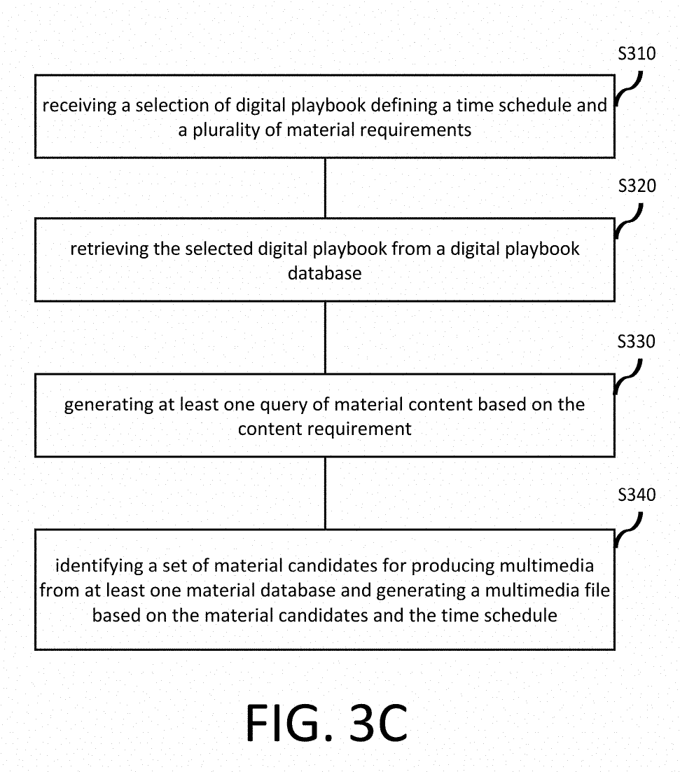

FIG. 3A illustrates an editing process for producing a multimedia file as a work product of the multimedia editing and generating system 100 of the present disclosure.

Referring to FIG. 3A, in step S110, the multimedia editing and generating system 100 may receive a playbook selection for digital playbooks. In at least one exemplary embodiment, the multimedia editing and generating system 100 may receive a playbook query and provide digital playbook candidates meeting the query before receiving the selection. The multimedia editing and generating system 100 may further retrieve a digital playbook corresponding to selected digital playbook from the playbook database 110.

In step S120, the multimedia editing and generating system 100 may receive material selections corresponding to material content requirements defined in the selected digital playbook and retrieve corresponding material contents form the material database 120. In at least one exemplary embodiment, the multimedia editing and generating system 100 may provide material content candidates meeting material content requirements defined in the digital playbook before receiving selections among the material content candidates. In at least one exemplary embodiment, the multimedia editing and generating system 100 may further generate digital script for each material content requirement for retrieving and providing material content candidates.

In step S130, the multimedia editing and generating system 100 may receive uploaded files as user contents corresponding to requirements defined in the digital playbook. In at least one exemplary embodiment, the multimedia editing and generating system 100 may provide hints corresponding to user content requirements defined in the digital playbook before receiving selections among the material content candidates. In at least one exemplary embodiment, the multimedia editing and generating system 100 may further generate a digital script for each user content requirement for providing corresponding hint. In at least one exemplary embodiment, a checking mechanism for each user content requirement may also be included in the digital scripts. Also, if the user content requirement involves real time recording, settings related to the real time recording may be included in the digital scripts.

In step S140, the multimedia editing and generating system 100 may synthesize the selected material contents and uploaded user contents to generate a multimedia file as a work product according to the digital playbook. In at least one embodiment, the multimedia editing and generating system 100 can transmit the multimedia file to a client device, or upload the multimedia file to a video sharing platform or a social media platform.

The synthesizing process is further illustrated in FIG. 3B as one exemplary embodiment of the present disclosure. In step S210, the multimedia editing and generating system 100 may retrieve a schedule from the digital playbook selected in step S110. The schedule, as illustrated in FIG. 2B may define required material contents, required user contents and the relationship between the required contents (including material contents and user contents) and time. In step S220, the multimedia editing and generating system 100 may match material contents selected in step S120 and user contents uploaded in step S130 to the schedule of the selected digital playbook. In at least one exemplary embodiment, in step S230, for each selected material content and uploaded user content, the multimedia editing and generating system 100 may further match corresponding configuration defined in the schedule of the selected digital playbook. In step S240, the multimedia editing and generating system 100 may generate and store a multimedia file as a work product by combining the selected material contents and uploaded user contents to the schedule and the configurations defined in the schedule.

FIG. 3C illustrates an editing process for producing a multimedia file as a work product of the multimedia editing and generating system 100 of the present disclosure.

Referring to FIG. 3C, in step S310, the multimedia editing and generating system 100 may receive a playbook selection for digital playbooks. In at least one exemplary embodiment, the multimedia editing and generating system 100 may receive a playbook query and provide digital playbook candidates meeting the query before receiving the selection. In at least one exemplary embodiment, the selected digital playbook defines a plurality of material requirements for at least one of the material contents and the user contents and a time schedule having one or more unit of time. The material requirements can include at least one of content requirements having at least one of a query, a one role, a hint, a check mechanism, and a configuration.

In step S320, the multimedia editing and generating system 100 may further retrieve a digital playbook corresponding to selected digital playbook from the playbook database 110.

In step S330, the multimedia editing and generating system 100 may generate at least one query of material content based on the content requirement. For example, as shown in FIG. 2C, the multimedia editing and generating system 100 may receive the at least one query from each of the content requirements.

In step S340, the multimedia editing and generating system 100 may identify a set of material candidates for producing multimedia from the material database 120 and generate a multimedia file based on the material candidates and the time schedule. In at least one exemplary embodiment, the multimedia editing and generating system 100 may search the material database 120 using the at least one query and check all of the material candidates in the set having metadata met the at least one query of the content requirement. In at least one exemplary embodiment, the multimedia editing and generating system 100 may receive selections among the material content candidates, and match the selected material candidate to the time schedule according to the relationship between the material requirement and the time schedule for generating the multimedia file. In at least one exemplary embodiment, the multimedia editing and generating system 100 may retrieve the time schedule having one or more unit of time and schedule the selected material candidate based on the at least one of the unit of time of the material requirement corresponding to the selected material candidate.

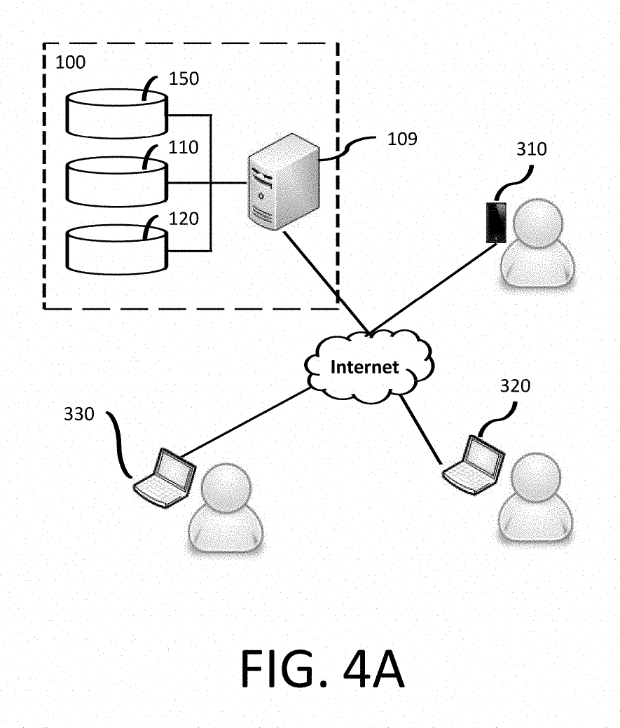

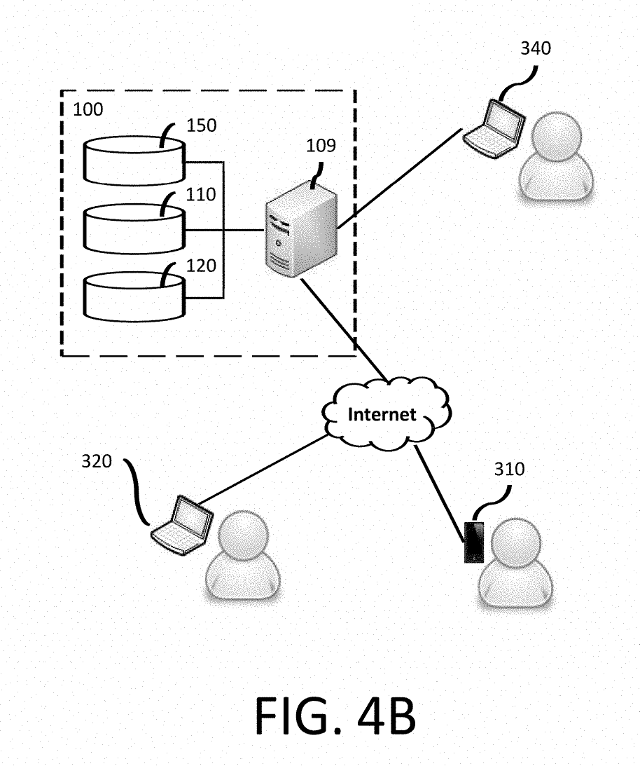

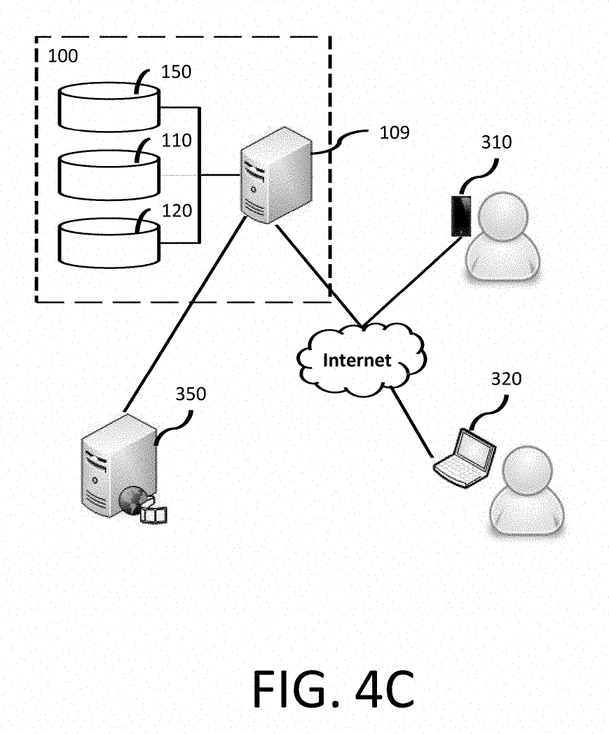

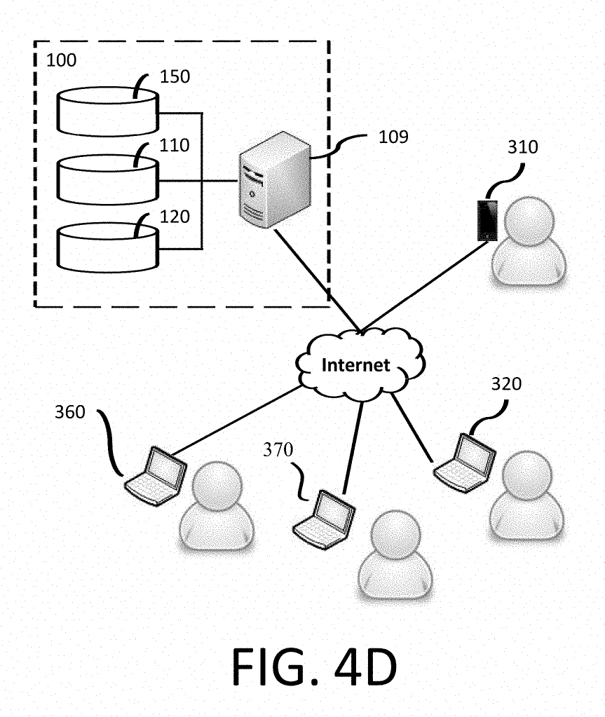

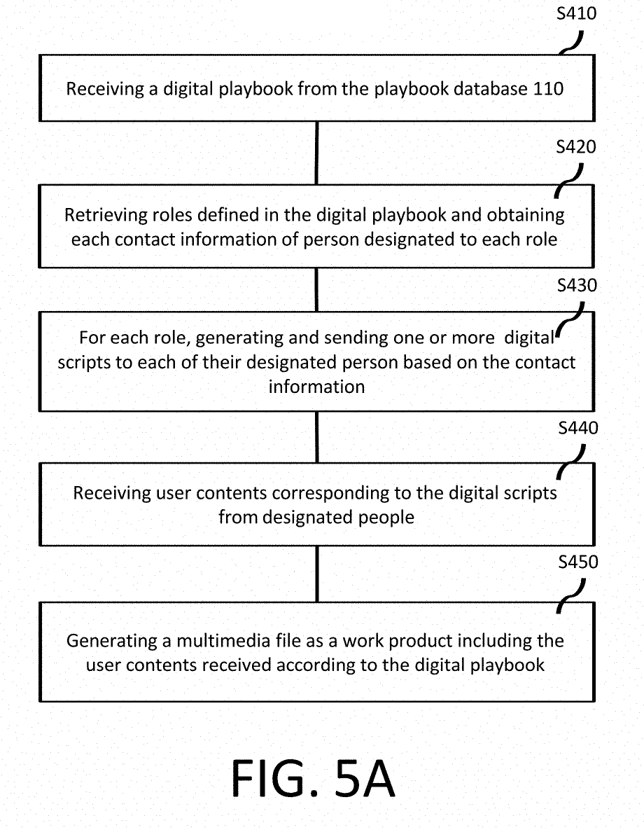

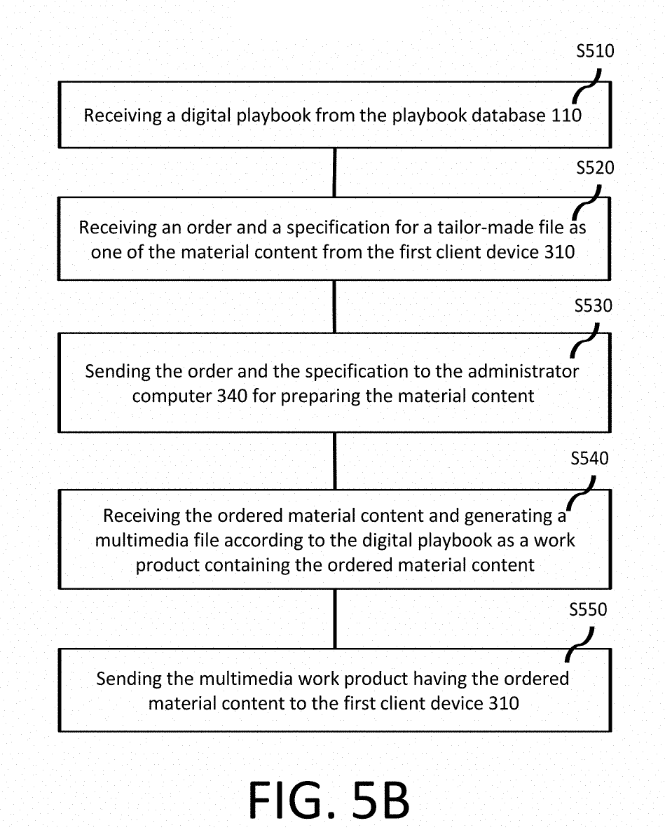

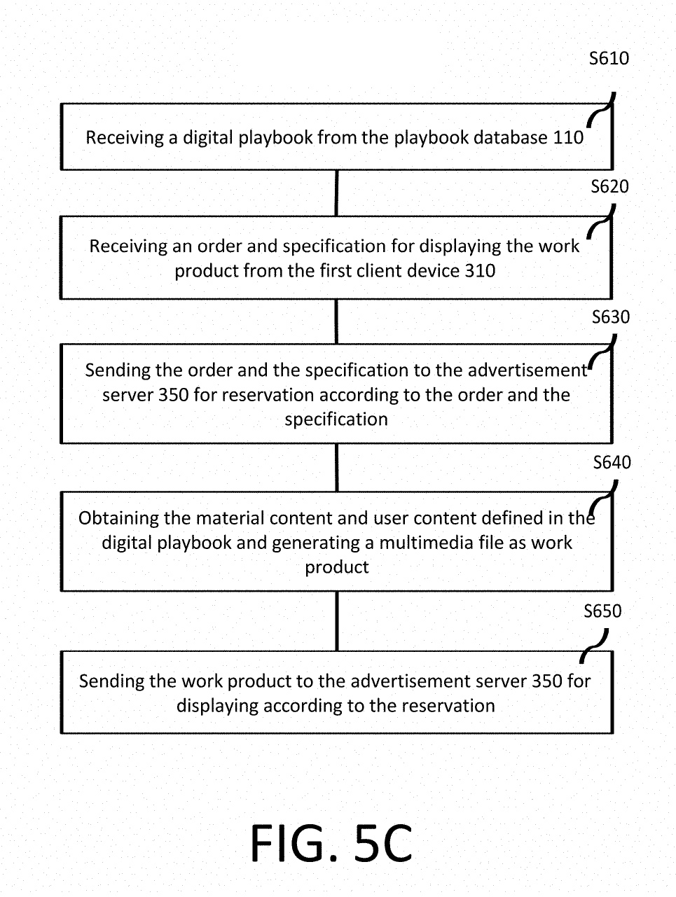

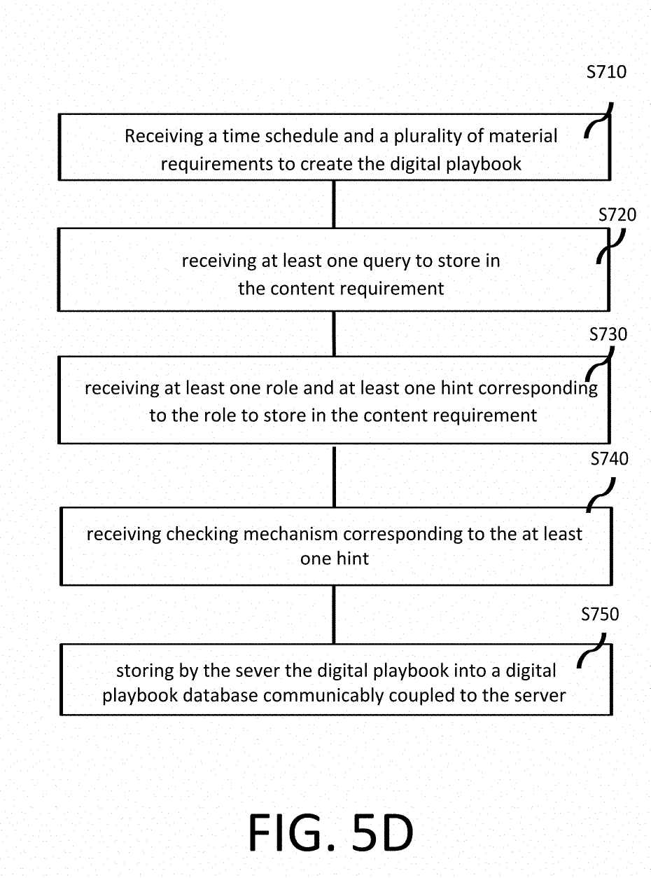

Referring to FIG. 4A and FIG. 5A, an exemplary embodiment of an online platform implementation of the multimedia editing and generating system 100 and a corresponding process of the present disclosure for providing collaboration between multiple users is illustrated. Referring to FIG. 4A and FIG. 1, the aforementioned editing and uploading module 130, the synthesizing module 140 and the file management module 160 may be implemented in an application server 109 which may be communicably connected with the playbook database 110, the material database 120 and the multimedia database 150. The application server 109 may provide cooperation between a first client device 310 and a second client device 320 for producing a work product defined by a digital playbook of the present disclosure.

The application server 109 of the present disclosure may be one or more servers, server clusters or data centers. In at least one exemplary embodiment, the application server 109 may be one or more virtual machines implemented in one or more servers, server clusters or data centers. The first client device 310 and the second client device 320 may respectively be any computing device with network communication and I/O module, such as a desktop computer, a laptop computer, a notebook computer, a tablet computer, a cell phone, a smart phone, a digital still camera or a video camcorder, wherein the first client device 310 and the second client device 320 may respectively upload files as user contents to the application server 109 through a website or through a programmed software implemented therein such as an application (app) downloaded from an application store (Apple App Store, Google Play . . . etc.).

Referring to FIG. 5A, in step S410, the application server 109 may receive a digital playbook from the playbook database 110. In at least one exemplary embodiment, a digital playbook selection and retrieval process between the application server and the first user device 310 may be performed before the step S410. The application server 109 may retrieve roles defined in the digital playbook and send to at least one of the first client device 310 and the second client device for receiving contact information of people designated to the roles. If the contact information is sent to the first client device, in step S420, the application server 109 may then receive contact information of each person designated to each role from the first client device 310. The contact information may include phone number, mail address or IP address of the first client device 310 and the second client device 320. In at least one exemplary embodiment, the application server 109 can provide the contact information to the first client device 310. For example, if the application server 109 may have the contact information of a singer, the first client device can pay for a dedicated user contents provided based on the hint of the content requirement from the singer. In at least one exemplary embodiment, if the first client device 310 uploads contact information stored in the first client device 310, the application server 109 can provide the hint of the content requirement to the second client device 320 based on the uploaded contact information from the first client device 310. In step S430, for each role defined in the digital playbook, the application server 109 may generate and send one or more of the aforementioned digital scripts to each of their designated person based on the contact information. In step S440, the first client device 310 and the second client device 320 may respectively receive the digital scripts and present user interfaces providing hints, checking mechanisms and/or recording settings for user uploading user contents according to the digital scripts. The application server 109 may therefore receive user contents corresponding to the digital script respectively from the first client device 310 and the second client device 320. In step S450, the application server 109 may generate a multimedia file as a work product including the user contents received according to the digital playbook. The multimedia file may be stored in the multimedia database 150 for the first client device 310 and/or the second client device 320 downloading through the application server 109. In at least one exemplary embodiment, the application server 109 may further be configured to send the multimedia file to a third client device 330. For example, the user of the first client device 310 may be a convener of the production of the multimedia file for a viewer of the third device 330. The user of the first client device 310 may therefore select a digital playbook and cooperate with the user of the second client device 320 to produce the multimedia through the aforementioned steps S410 to S450 according to the digital playbook. The application server 109 may send the multimedia file as the work product to the third client device 330 after receiving a sending request from the first client device.

In at least one exemplary embodiment, the application server 109 may also provide user interfaces for selecting material contents to the first client device 310. The application server 109 may retrieve material contents from the material database 120 according the selections received from the first client device 310. The multimedia file generated by the application server 109 may therefore contain the selected material contents. Similarly, the application server 109 may also provide user interfaces to the first client device 310 for adjusting configurations of the user contents and the material contents and generate the multimedia file as the work product based on the adjusted configurations received from the first client device 310.

Referring to FIG. 4B and FIG. 5B, an exemplary embodiment of an online platform implementation of the multimedia editing and generating system 100 and a corresponding process of the present disclosure to provide ordering of material contents is illustrated. Referring to FIG. 4B and FIG. 1, the aforementioned application server 109 may further communicably connected to an administrator computer 340.

The administrator computer 340 may be any computing device with network communication and I/O module communicably connected to the application server 109. In at least one exemplary embodiment, the connection may be established through a private network including both the administrator computer 340 and the application server 109. In at least one exemplary embodiment, the connection may be established through the internet. In at least one exemplary embodiment, the administrator computer 340 a virtual machine implemented within a server. In at least one exemplary embodiment, the application server 109 may be also a virtual machine implemented within the server. In at least one exemplary embodiment, the application server 109 may be the server where the administrator computer 340 implemented within.

Referring to FIG. 5B, in step S510, the application server 109 may receive a digital playbook from the playbook database 110. In at least one exemplary embodiment, a digital playbook selection and retrieval process between the application server and the first user device 310 may be performed before the step S510. In at least one exemplary embodiment, the application server 109 may retrieve material content candidates according to material content requirements defined in the digital playbook and send to the first client device 310 for receiving selections among the material candidates. However, if the user of the first client device 310 not satisfies with the material candidates. The application server 109 may also provide one or more user interfaces for ordering a tailor-made file following a specification corresponding to a material content requirement defined in the digital playbook. In step S520, the application server 109 may receive an order and a specification corresponding to the material content requirement from the first client device 310. In step S530, the application server 109 may send the order and the specification to the administrator computer 340 for preparing the material content. In at least one exemplary embodiment, whether via the application server 109 or not, the administrator computer 340 may provide a fee schedule and a requirement of payment corresponding to the order to the first client device 310. The administrator computer 340 and/or the application server 109 may receive a notification from a payment server providing payment service if the payment is accomplished. In step S540, the application server 109 may receive the ordered material content according to the specification. The application server 109 may further generate a multimedia file as a work product according to the selected digital playbook. The multimedia file may therefore contain the ordered material content. In step S550, the application server 109 may send the multimedia file to the first client device 310 or, in some exemplary embodiments, the third client device 330.

In at least one exemplary embodiment, the application server 109 may provide the order and the specification in a public web site implemented therein for outsourcing. Any person accessing the order and the specification may decide whether to accomplish the task for providing the ordered material content. If the user of the second client device 320 decides to accomplish task, the application server 109 may receive the ordered material content from the second client device 320. The application server 109 may further generate the work product including the ordered material content in step S540 and send to the first client device 310.

Referring to FIG. 4C and FIG. 5C, an exemplary embodiment of an online platform implementation of the multimedia editing and generating system 100 and a corresponding process of the present disclosure to provide reservation of displaying work products as advertisement is illustrated. Referring to FIG. 4C and FIG. 1, the aforementioned application server 109 may further communicably connected to an advertisement server 350.

The advertisement server 350 may be one or more servers, server clusters, data centers and virtual machines. In at least one exemplary embodiment, the advertisement server 350 may communicably connected to a broadcasting system for broadcasting multimedia to output mechanisms such as display devices, televisions, digital signage (public information displays), radio stations, website banners and web page advertisements.

Referring again to FIG. 5C, in step S610, the application server 109 may receive a digital playbook from the playbook database 110. In at least one exemplary embodiment, a digital playbook selection and retrieval process between the application server and the first user device 310 may be performed before the step S610. In at least one exemplary embodiment, the application server 109 may provide user interfaces to the first user device 310 for user selecting material contents and uploading user contents according to the selected digital playbook. The application server 109 may further provide one or more user interfaces for ordering time and places (or channels including websites) for displaying the work product corresponding to the digital playbook. In step S620, the application server 109 may receive the order and the specification including detailed time and places (or channels including websites) for displaying the work product from the first client device 310. In step S630, the application server 109 may send the order and the specification to the advertisement server 350 for reserving the time and places (or channels including websites) in the specification for displaying the work product. In at least one exemplary embodiment, before providing the user interface for reserving time and places (or channels including websites) to the first client device 310, the application server 109 may receive available time, places or channels for reservation from the advertisement server 350. The application server 109 may therefore provide only the available time, places or channels for ordering to the first client device. In step S640, the application server 109 may further obtain material contents and user contents defined in the digital playbook and generate a multimedia file according to the digital playbook as the work product. In step S650, the application server 109 may send the work product to the advertisement server 350 for displaying according to the reserved time, places and channels. The advertisement server 350 may therefore display the work product according to the reserved time, places and channels.

Referring to FIG. 4D and FIG. 5D, an exemplary embodiment of an online platform implementation of the multimedia editing and generating system 100 and a corresponding process of the present disclosure for providing collaboration between multiple users is illustrated. Referring to FIG. 4D and FIG. 1, the aforementioned editing and uploading module 130, the synthesizing module 140 and the file management module 160 may be implemented in an application server 109 which may be communicably connected with the playbook database 110, the material database 120 and the multimedia database 150. The application server 109 may create a digital playbook by receiving some information from a playbook creation device 360, store material contents uploaded by the material provider device 370 into the material database 120 and provide cooperation between a first client device 310 and a second client device 320 for producing a work product defined by the digital playbook of the present disclosure

The playbook creation device 360 and the material provider device 370 may respectively be any computing device with network communication and I/O module, such as a desktop computer, a laptop computer, a notebook computer, a tablet computer, a smart phone, a digital still camera or a video camcorder. The playbook creation device 360 may upload a time schedule and a plurality of material requirements to the application server 109 to create the digital book through a website or through a programmed software implemented therein such as an application (app) downloaded from an application store (Apple App Store, Google Play . . . etc.). The material provider device 370 may upload the material contents having metadata to the application server 109 to update the material database 120 through a website or through a programmed software implemented therein such as an application (app) downloaded from an application store (Apple App Store, Google Play . . . etc.).

Referring to FIG. 5D, in step S710, the application server 109 may receive from the playbook creation device 360 a time schedule and a plurality of material requirements to create the digital playbook. In at least one exemplary embodiment, the time schedule may include one or more unit of time. In at least one exemplary embodiment, the application server 109 may receive a mapping of material requirement to at least one of the units of time from the playbook creation device 360. Thus, the application server 109 schedules the material contents based on the at least one of the unit of time corresponding to the material contents when the first client device 310 generates the multimedia file based on the digital playbook by the application server 109.

In step S720, the application server 109 may receive from the playbook creation device 360 at least one query to store in the content requirement. In at least one exemplary embodiment, the application server 109 may use the at least one query of material contents based on the content requirement when the first client device 310 generates the multimedia file based on the digital playbook. The application server 109 may receive a plurality of material content candidate having metadata met the at least one query from the material database 120. The application server 109 may receive a selection of material candidate from the first client device 310 to generate the multimedia file based on the selected material candidate and the time schedule.

In step S730, the application server 109 may receive from the playbook creation device 306 at least one role and at least one hint corresponding to the role to store in the content requirement. In at least one exemplary embodiment, the playbook creation 306 may provide the at least one role and at least one hint for the user content requirements. In at least one exemplary embodiment, the first client device 301 may receive the at least one role and provide a designation for each role to the application server 109 when the multimedia file is generated based on the digital playbook. For example, the application server 109 may receive contact information of each person designated to each role from the first client device 310. The contact information may include phone number, mail address or IP address of the first client device 310 and the second client device 320. In at least one exemplary embodiment, the application server 109 can transmit the at least one hint to the first client device 301 or the second client device 320 based on the designation. In at least one exemplary embodiment, the first client device 301 or the second client device 320 can upload the user content based on the received hint.

In step 740, the application server 109 may receive from the playbook creation device 306 checking mechanism corresponding to the at least one hint. In at least one exemplary embodiment, the application server 109 can check the uploaded user contents based on the checking mechanism when the application server 109 receives the uploaded user contents from the first client device 301 or the second client device 320. In at least one exemplary embodiment, the application server 109 can transmit the checking mechanism to the first client device 301 or the second client device 320 based on the designation. Then, the first client device 301 or the second client device 320 can check the user contents based on the checking mechanism before the first client device 301 or the second client device 320 uploads the user content to the application server 109.

In step S750, the application server 109 may store the digital playbook into the playbook database 110. In at least one exemplary embodiment, the first client device 301 or the second client device can use the stored digital playbook to generate the multimedia file. In at least one exemplary embodiment, the user of the first client device 310 may therefore select a digital playbook from the playbook database 110 and cooperate with the user of the second client device 320 to produce the multimedia according to the digital playbook.

In at least one exemplary embodiment, the application server 109 may also provide user interfaces for creating the digital playbook to the playbook creation device 360. Similarly, the application server 109 may also provide user interfaces to the material provider device 370 for uploading material contents to the material database 120. Thus, the query results of the material contents will be changeable if the material provider device 370 keeps updating the material database 120. In at least one exemplary embodiment, the material contents can be provided by the administrator computer 340, and the user device including the first client device 310, the second client device 320, the third client device 330, the playbook creation device 360, the material provider device 370. Thus, the material contents can be provided from the singer's or actor's device for the user to produce the multimedia file with the singer's or the actor's video.

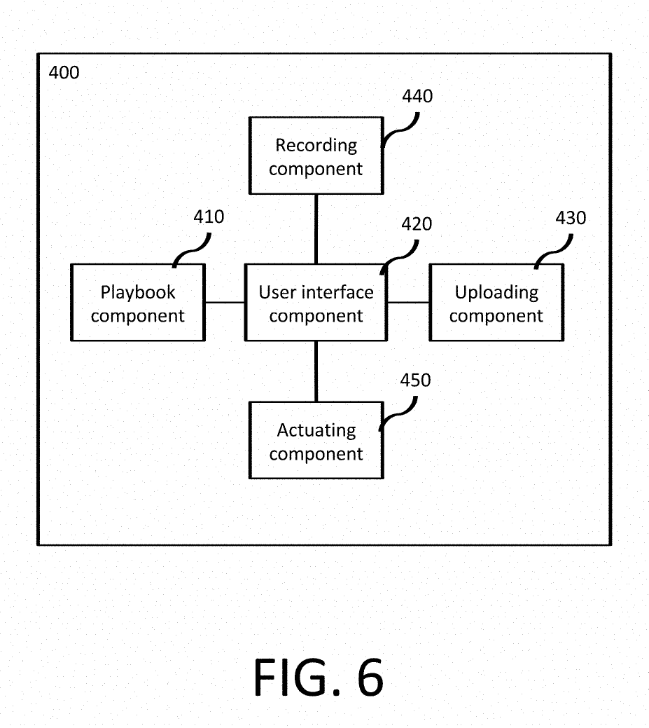

Referring to FIG. 6, an exemplary embodiment of client side configuration corresponding to the application server 109 of the multimedia editing and generating system 100 is illustrated. The client side configuration may be implemented as a software and/or hardware system (denoted as the client module 400) which may be implemented in the client devices 310 and 320 as illustrated in FIG. 5A. The client module 400 may include a playbook component 410 analyzing digital playbooks received from the application server 109. The playbook component 410 may extract the material content and user content requirements along with the schedule and/or configurations corresponding to the content requirements from the received digital playbook. In at least one exemplary embodiment, the playbook component 410 may generate digital scripts including the extracted content requirements.

The client module 400 may also include a user interface component 420 providing user interfaces for querying and selecting digital playbooks, suggesting and selecting material contents corresponding to requirements extracted from the selected digital playbooks, guiding and receiving user contents corresponding to requirements extracted from the selected digital playbooks and editing the schedule and/or configurations extracted from the selected digital playbooks.

The client module 400 may further comprise an uploading component 430 for uploading material content selections, the user contents received and the selected digital playbooks to the application server 109. The application server 109 may generate retrieve material contents according to the material content selections and generate multimedia files as work products according to the selected digital playbooks. In at least one exemplary embodiment, the edited schedule and the configurations may also be uploaded to the application server 109 by the uploading component 430 for generate the work products accordingly.

In at least one exemplary embodiment, the client module 400 may further comprise a recording component 440 for recording multimedia as user contents. In at least one exemplary embodiment, the recording component 440 may extract settings from the digital scripts generated by the playbook component 410. The recording component 440 may record multimedia with the extracted settings as user contents corresponding to the digital scripts.

In at least one exemplary embodiment, the client module 400 may further comprise an actuating component 450 for producing physical outputs to be recorded by recording devices including the recording component 440 in the former paragraph. In at least one exemplary embodiment, the actuating component 450 may also extract settings from the digital scripts generated by the playbook component 410. The actuating component 450 may therefore produce physical outputs with the extracted settings from the digital scripts.

In at least one exemplary embodiment, the actuating component 450 may produce physical outputs having a specific pattern in time sequence according to a digital playbook. The pattern in time sequence may provide a standard for synchronizing multiple recording progresses of the client module 400. For example, in some exemplary embodiments, the actuating component 450 may produce a pattern of sounds as beats for the recording component 440 determining timing for recording music and/or video. The pattern of sounds may be a common basis for recording multiple user contents. Therefore, the multiple user contents may be synchronized and played simultaneously in the work product under the definition of the digital playbook. In at least one exemplary embodiment, the pattern of sounds may be generated according to the digital playbook. The pattern of sounds may also be the common basis for synchronizing multiple user contents and one or more material content. For example, a music file as material content may be defined in a digital playbook. A file defining beats of the music file may be defined as requirements of user contents in the digital playbook. Therefore, uploaded files corresponding to the user contents may be in line with the beats of the music as the material content. Additionally, in at least one exemplary embodiment, the user contents may be assigned to multiple roles for their respectively recording and uploading. The user contents may also be synchronized by recording in line with the beats.

In at least one exemplary embodiment, a digital playbook may also define multiple physical outputs each with corresponding pattern. Each of the corresponding patterns may correspond to one or more user content requirements defined in the digital playbook. For example, a read draft defining timing for speeches to be recorded may be defined in the digital playbook as a requirement for an audio file including a speech of a first user as first user content. A metronome may also be defined in the digital playbook as a requirement for an audio file including music played by a second user as second user content. The first and second user contents may be played simultaneously in the work product according to the digital playbook. Therefore, the first user and the second user may record for the requirements separately but still complementary with each other as long as both the first user and the second user follow the requirements.

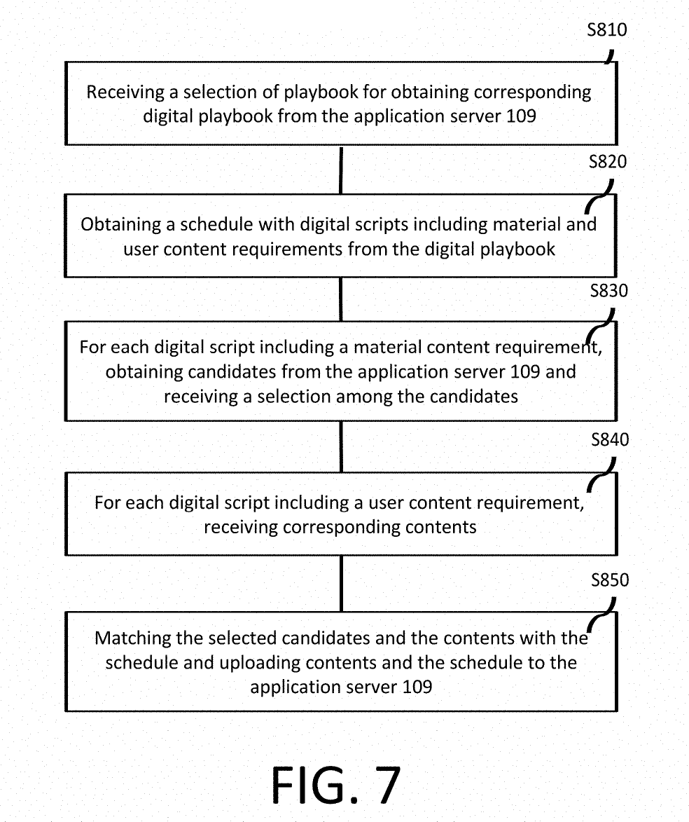

Referring to FIG. 7, the client module 400 may receive and provide a list of digital playbooks for selection. In step S810, the client module 400 may receive a selection of the listed playbook for obtaining the corresponding digital playbook from the application server 109. In at least one exemplary embodiment, the client module 400 may send the selection to the application server 109 and receive the corresponding digital playbook. In step S820, the client module 400 may analyze the digital playbook through the playbook component 410 to retrieve a schedule from the digital playbook and generate digital scripts including material content requirements and user content requirements retrieved from the digital playbook. In step S830, for each digital script including a material content requirement, the client module 400 may obtain material content candidates from the application server 109 and receive corresponding selection among the candidates. In step S840, for each digital script including a user content requirement, the client module 400 may receive user content corresponding to the requirement. In step S850, the client module 400 may match the selected material content candidates and the received user contents with the schedule extracted from the digital playbook. The client module 400 may upload the matched schedule, the selected material content candidates and the received user contents to the application server 109 for synthesizing into a multimedia file as a work product through the uploading component 430.

Previous descriptions are only exemplary embodiments of the present disclosure and are not intended to limit the scope of the present disclosure. Many variations and modifications according to the disclosure are still within the scope of the present disclosure. Additionally, each of the exemplary embodiments does not have to achieve all the advantages or characteristics disclosed. Moreover, the abstract and the title only serve to facilitate searching patent documents and are not intended in any way to limit the scope of the present disclosure.

What is claimed is:

1. A machine-implemented method for producing multimedia by a server, the method comprising:
receiving from a computing device a selection of digital playbook which defines a time schedule and a plurality of material requirements, wherein at least one of the material requirements comprises at least one content requirement;
retrieving by the server the selected digital playbook from a digital playbook database communicably coupled to the server;
for each content requirement corresponding to one of the plurality of material requirements defined in the selected digital playbook, generating by the server at least one query of material content based on the content requirement;
for each material requirement comprising the at least one content requirement defined in the selected digital playbook, identifying a set of material candidates for producing multimedia from at least one material database communicably coupled to the server, wherein all the material candidates in the set comprise metadata met the generated at least one query corresponding to the at least one content requirement of the material requirement; and
generating by the server a multimedia file based on the material candidates and the time schedule.

2. The method of claim 1, comprising:
for each material requirement having a corresponding set of material candidates, receiving a selection of a material candidate from the computing device, retrieving the selected material candidate from the at least one material database, and mapping the selected material candidate to the time schedule according to the relationship between the material requirement and the time schedule; and
generating by the server the multimedia file based on the selected material candidate and the time schedule.

3. The method of claim 2, comprising:
retrieving the time schedule having one or more unit of time defined in the selected digital playbook, wherein each material requirement is mapped to at least one of the units of time; and
for each material requirement, scheduling by the server the selected material candidate to generate the multimedia file based on the at least one of the unit of time of the material requirement corresponding to the selected material candidate.

4. The method of claim 2, comprising:
retrieving by the sever a plurality of configurations of the material requirements defined in the selected digital playbook; and
adjusting by the server the selected material candidate to generate the multimedia file based on the configurations.

5. The method of claim 1, comprising:
for each material requirement having no corresponding set of material candidates, receiving a user content from one of at least one client device including the computing device, and mapping the user content to the time schedule according to the relationship between the material requirement and the time schedule; and
generating by the server the multimedia file based on the user content and the time schedule.

6. The method of claim 5, comprising:
for each material requirement having no corresponding set of material candidates, retrieving at least one role corresponding to the material requirement defined in the selected digital book;
receiving from the computing device a designation of the at least one role;
for each role of the corresponding material requirement, retrieving at least one hint based on the at least one content requirement of the material requirement; and
providing by the server the at least one hint to the one of the at least one client device based on the designation.

7. The method of claim 6, wherein the one of the least one client device receives the at least one hint from the server and provides the user content based on the at least one hint to the server.

8. The method of claim 6, comprising:
for each role of the corresponding material requirement, generating checking mechanism corresponding to the at least one hint based on the at least one content requirement of the material requirement; and
checking by the server whether the received user content meets the at least one content requirement.

9. The method of claim 6, comprising:
for each role of the corresponding material requirement, generating checking mechanism corresponding to the at least one hint based on the at least one content requirement of the material requirement;
providing by the server the checking mechanism to the one of the at least one client device based on the designation; and
checking by the one of the at least one client device whether the user content meets the at least one content requirement.

10. The method of claim 1, comprising:
receiving from a playbook creation device the time schedule and the plurality of material requirements to create the selected digital playbook;
for each content requirement corresponding to each material requirement defined in the selected digital playbook, receiving from the playbook creation device the at least one query for generating the content requirement based on the at least one query; and
storing by the sever the selected digital playbook into the digital playbook database.

11. A machine-implemented method for creating a digital playbook by a server for producing multimedia based on the digital playbook, the method comprising:
receiving from a computing device a time schedule and a plurality of material requirements to create the digital playbook, wherein at least one of the material requirements comprises at least one content requirement;
for each content requirement corresponding to one of the plurality of material requirements defined in the digital playbook, receiving from the computing device at least one query to store in the content requirement, wherein the server identifies a set of material candidates having metadata met the received at least one query corresponding to the content requirement from at least one material database communicably coupled to the server when the server generates a multimedia file based on the digital playbook; and
storing by the sever the digital playbook into a digital playbook database communicably coupled to the server.

12. The method of claim 11, comprising:
retrieving by the sever the digital playbook from the digital playbook database;
for each content requirement corresponding to each material requirement defined in the digital playbook, generating by the server the at least one query of material content based on the content requirement;
for each material requirement having at least one content requirement defined in the digital playbook, identifying the set of material candidates for producing multimedia from the at least one material database communicably coupled to the server; and
generating by the server the multimedia file based on the material candidates and the time schedule.

13. The method of claim 12, comprising:
receiving from the computing device the time schedule having one or more unit of time; and
for each material requirement defined in the digital playbook, receiving from the computing device a mapping of the material requirement to at least one of the units of time, wherein the server schedules the selected material candidate to generate the multimedia file based on the at least one of the unit of time of the material requirement corresponding to the selected material candidate.

14. The method of claim 12, comprising:
for each material requirement defined in the digital playbook, receiving from the computing device a plurality of configurations of the material requirement to define in the digital playbook; and
storing the plurality of configurations corresponding to the material requirement defined in the digital playbook, wherein the server adjusts the selected material candidate to generate the multimedia file based on the configurations when the server generates the multimedia file based on the digital playbook.

15. The method of claim 12, comprising:
for each material requirement having a corresponding set of material candidates, receiving a selection of a material candidate from the computing device, retrieving the selected material candidate from the at least one material database, and mapping the selected material candidate to the time schedule according to the relationship between the material requirement and the time schedule; and
generating by the server the multimedia file based on the selected material candidate and the time schedule.

16. The method of claim 12, comprising:
receiving from the computing device at least one role defined in the digital playbook; and
for each role, receiving from the computing device at least one hint corresponding to the role to generate the content requirement.

17. The method of claim 16, comprising:
for each material requirement having no corresponding set of material candidates, retrieving the at least one role based on the at least one content requirement of the material requirement defined in the digital playbook;
receiving from a multimedia generation device a designation of the at least one role;
for each role, retrieving at least one hint based on the content requirement defined in the digital playbook; and
providing by the server the at least one hint to at least one client device including the multimedia generation device based on the designation.

18. The method of claim 17, comprising:
receiving a user content from one of at least one client device, and mapping the user content to the time schedule according to the relationship between the material requirement and the time schedule; and
generating by the server the multimedia file based on the user content and the time schedule.

19. The method of claim 18, wherein the one of the least one client device receives the at least one hint from the server and provides the user content based on the at least one hint to the server.

20. The method of claim 18, comprising:
receiving from the computing device checking mechanism corresponding to the at least one hint for generating the content requirement; and
storing by the server the checking mechanism in the digital playbook into the digital playbook database for checking whether the received user content meets the content requirement when the multimedia generation device generates the multimedia file.
